(19) United States
(12) Patent Application Publication
(10) Pub. No.: US 2004/0252330 A1
(43) Pub. Date: Dec. 16, 2004

(54) Method and apparatus for faxing with a multifunction printer

(76) Inventors: Mark L. Brown, Boise, ID (US); Vincent C. Skurdal, Boise, ID (US); David Alan Bartle, Boise, ID (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 10/461,196

(22) Filed: Jun. 13, 2003

(51) Int. Cl. G06F 15/00

(52) U.S. Cl. 358/1.15; 358/400

(57) ABSTRACT

A method for use in faxing with a multifunction printer. A control sheet indicative of a set of files accessible by the printer is printed. The control sheet is optically scanned so as to recognize marks made by a user which are indicative of at least one designated file. The designated files are rendering into fax-formatted output data, and at least some of the output data is faxed to each of at least one designated destination.

### BACKGROUND OF THE INVENTION

Many electronic devices are capable of creating or accessing data files stored in digital form on memory devices. One such device is a digital camera, which is capable of capturing digital images such as photographs and storing these images as data files formatted according to, for example, popular image file formats such as JPG or GIF. Another such device is a PDA (personal digital assistant), handheld, notebook, or laptop computer which is capable of generating digital documents such as text, spreadsheets, or graphics presentations as data files formatted according to, for example, popular document file formats such as DOC, RTF, PDF, XLS, or PPT. These images and documents are generally capable of being rendered in a visual form on a display device or on printed media.

A person who creates or has access to these data files often desires to quickly and easily share them with others who are located at a distance. For example, one family member may wish to share data files representing digital photographs with another family member who lives across the country. A business person may desire to have a partner in another location review a document. However, some of these intended recipients may not be able to receive or view these data files. For example, while a family member typically has telephone service, he or she may not own a computer, may not be skilled in using one, or may not have access to a communication network such as the Internet for receiving the files. A business partner may be traveling on business in a locale without a computer or Internet service.

For these and other reasons, there is a need for the present invention.

### SUMMARY OF THE INVENTION

The above-stated needs and others are met, for example, by one embodiment of the present invention that provides a method for use in faxing with a multifunction printer. A control sheet indicative of a set of files accessible by the printer is printed. The control sheet is optically scanned so as to recognize marks made by a user which are indicative of at least one designated file. The designated files are rendering into fax-formatted output data, and at least some of the output data is faxed to each of at least one designated destination.

### BRIEF DESCRIPTION OF THE DRAWINGS

The features of the present invention and the manner of attaining them, and the invention itself, will be best understood by reference to the following detailed description of embodiments of the invention, taken in conjunction with the accompanying drawings, wherein:

FIG. 1 is a block diagram of a faxing system in accordance with one embodiment of the present invention;

FIG. 2 is a block diagram of a faxing system in accordance with another embodiment of the present invention;

FIG. 3 is a perspective diagram of an embodiment according to the present invention of a multifunction printer usable with the system of FIG. 1 and FIG. 2;

FIG. 4 is a schematic diagram of one embodiment according to the present invention of a fax control sheet printed by a multifunction printer such as the printer of FIG. 3 and usable with the faxing system of FIG. 1 and FIG. 2;

FIG. 5 is a schematic diagram of an exemplary user-marked copy of the fax control sheet of FIG. 4 indicating exemplary user markings in designator regions of the sheet;

FIG. 6 is a schematic diagram of an embodiment according to the present invention of a fax modeset usable with the system of FIG. 1 and FIG. 2;

FIG. 7 is a top-level flowchart in accordance with an embodiment of the present invention of a method for use in faxing with a multifunction printer;

FIG. 8 is a lower-level flowchart of one embodiment according to the present invention of a portion of the method of FIG. 7 for printing a fax control sheet;

FIG. 9 is a lower-level flowchart of one embodiment according to the present invention of a portion of the method of FIG. 7 for optically scanning the fax control sheet;

FIG. 10 is a lower-level flowchart of one embodiment according to the present invention of a portion of the method of FIG. 7 for rendering designated data files into fax-formatted output data;

FIG. 11 is a lower-level flowchart of one embodiment according to the present invention of a portion of the method of FIG. 10 for visually rendering file data; and

FIG. 12 is a lower-level flowchart of one embodiment according to the present invention of a portion of the method of FIG. 7 for faxing the output data to fax destinations.

### DESCRIPTION OF THE PREFERRED EMBODIMENT

Referring now to the drawings, there is illustrated an embodiment of a multifunction printer constructed in accordance with the present invention which may be used to transmit designated data files to designated recipients over a telephone network via a facsimile (fax) protocol. The fax operation to be performed is specified by a fax control sheet that is produced by the printer and then marked by the user. In operation, the multifunction printer prints the fax control sheet with markable designators corresponding to accessible data files and potential recipients. After the user has made the desired designations, the multifunction printer scans the marked fax control sheet and faxes the designated files to the designated recipients as specified by the user.

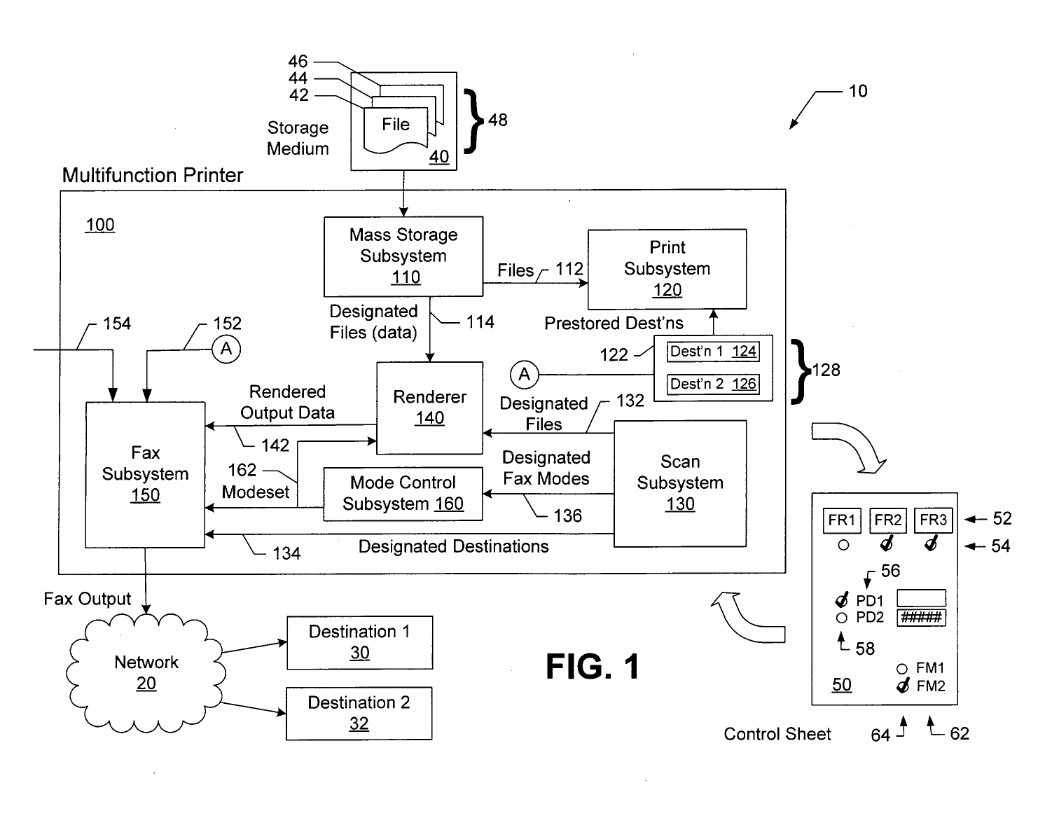

Considering now one embodiment of the present invention, and with reference to FIG. 1, a system 10 includes a multifunction printer 100 connected to a network 20, such as, but not limited to, a telephone network, through which a connection can be made to one or more selected destinations, such as destinations 30,32. Each destination 30,32 may be a fax machine, a fax interface of a computer system, or the like. A connection from the printer 100 to a destination 30,32 can be established by the printer 100 according to a network protocol. Where the network is a telephone network, for example, the printer 100 may dial the telephone number of a desired destination 30,32.

A mass storage subsystem 110 of printer 100 is adapted to access data files, such as data files 42,44,46, stored on one or more storage media, such as storage medium 40, coupled to printer 100. In one embodiment, storage medium 40 may be a non-volatile memory device, such as a compact flash card, memory stick, or the like, which is insertable into a mating connector of mass storage subsystem 110. Such types of storage media are frequently used by electronic devices such as digital cameras, digital camcorders, palm computers, and laptop or notebook computers to store data files. In many cases the storage media can be removed from the electronic device. Mass storage subsystem 110 can provide information about the data files 42,44,46, or the contents of data files 42,44,46, to a print subsystem 120 via pathway 112.

The print subsystem 120 is adapted to print a fax control sheet 50 indicative of a set of the files 42,44,46 and indicative of a set of possible fax destinations. The set of files may include some or all of the files on the storage media accessible by printer 100. The set of possible fax destinations may include some or all of the destinations prestored in a data store 122 of the printer 100. As illustrated in FIG. 1, for example, file set 48 includes all three files 42,44,46, while destination set 128 includes prestored fax destinations 124,126. The set of possible fax destinations may also include one or more fax destinations which are not prestored in data store 122, but are specified by the user instead.

The fax control sheet 50 is printed on a print medium such as paper or transparency film. The control sheet 50, as will be discussed subsequently in greater detail, includes a file representation 52 and a file designator 54 for each file in the file set, and a destination representation 56 and a designator designator 58 for each possible fax destination. A user of the system 10 may make markings on the control sheet 50 with a marking implement such as a pencil, pen, marker, or the like. The markings made by the user are indicative of at least one designated file in the set of files, and at least one designated destination in the set of potential destinations.

After making the markings, the user may position the control sheet 50 in optical contact with a scan subsystem 130. The scan subsystem 130 is adapted to optically scan the control sheet 50 so as to recognize the designators 54,58 marked by the user. By associating the marks with representations 52,56, the scan subsystem 130 identifies the designated files in file set 48 and the designated destinations in the possible fax destination set 128. For example, FIG. 1 illustrates that files 44,46 (associated with file representations FR2 and FR3) and fax designation 124 (associated with destination representation PD1) have been designated, as indicated by the checkmarks in their corresponding file designators 54.

The identification of the designated files is provided by the scan subsystem 130 over pathway 132 to a renderer 140 which is adapted to render the designated files into fax-formatted output data. The renderer 140 obtains the designated files from the mass storage subsystem 110 via pathway 114. As will be discussed subsequently in greater detail, the renderer 140 interprets the data contents of each designation file according to its file format, and generates fax-formatted output data corresponding to a visual rendition of the file.

A fax subsystem 150 is adapted to fax at least some of the output data to each designated destination. In embodiments where network 20 is a telephone network, the fax subsystem 150 may be capable of connecting directly to the telephone network. In other embodiments where network 20 includes both a telephone network, and a computer network such as the Internet, the fax subsystem 150 may be capable of connecting to a network-to-fax server or gateway (not shown) of the computer network, which in turn connects to the telephone network. The fax-formatted output data is received by the fax subsystem 150 from the renderer 140 over pathway 142, and the designated destinations are received by the fax subsystem 150 from the scan subsystem 130 via pathway 134.

In some embodiments, additional designated destinations may be communicated to the fax subsystem 150 other than via pathway 134. For example, one or more default destinations from data store 122 may be provided to fax subsystem 150 via pathway 152. Some or all of these default destinations may be used as designated destinations in addition to designated destinations received from scan subsystem 130. Or, if no designated destinations are received from scan subsystem 130 because the user did not mark any destination designators 58 on control sheet 50, some or all of these default destinations may be used as designated destinations instead. Also, at least one user-entered destination may be directly provided to fax subsystem 150 by the user over pathway 154 which provides a user interface to printer 100. For example, via the user interface the user may directly dial a fax number to which the designated files would be sent.

The printer 100 may also include a mode control subsystem 160 that is adapted to provide a fax modeset to the renderer 140 and the fax subsystem 150 via pathway 162. The fax modeset, as will be described subsequently in greater detail, is a set of fax operating parameters that collectively govern fax rendering, transmission, or both. In some embodiments, the print subsystem 120 prints fax mode representations 62 and fax mode designators 64 on the fax control sheet 50. The scan subsystem 130 recognizes the designators 64 marked by the user, and by associating the marks with representations 62, the scan subsystem 130 identifies the designated fax modes. For example, FIG. 1 illustrates that fax mode FM2 has been designated, as indicated by the checkmark in its corresponding fax designator. The mode control subsystem 160 receives the designated fax modes from the scan subsystem 130 via pathway 136, and determines or modifies the fax modeset in response. The renderer 140 and the fax subsystem 150 operate in accordance with the fax modeset received from the mode control subsystem 160.

The above-described multifunction printer 100 may be implemented using hardware, software, firmware, or a combination of these technologies. Subsystems, or portions of subsystems, of the printer 100 can be implemented using dedicated mechanical and electrical hardware, or a combination of dedicated hardware along with a computer or microprocessor controlled by firmware or software. Dedicated electrical hardware may include discrete or integrated analog circuitry and digital circuitry such as programmable logic device and state machines. Firmware or software may define a sequence of logic operations and may be organized as modules, functions, or objects of a computer program.

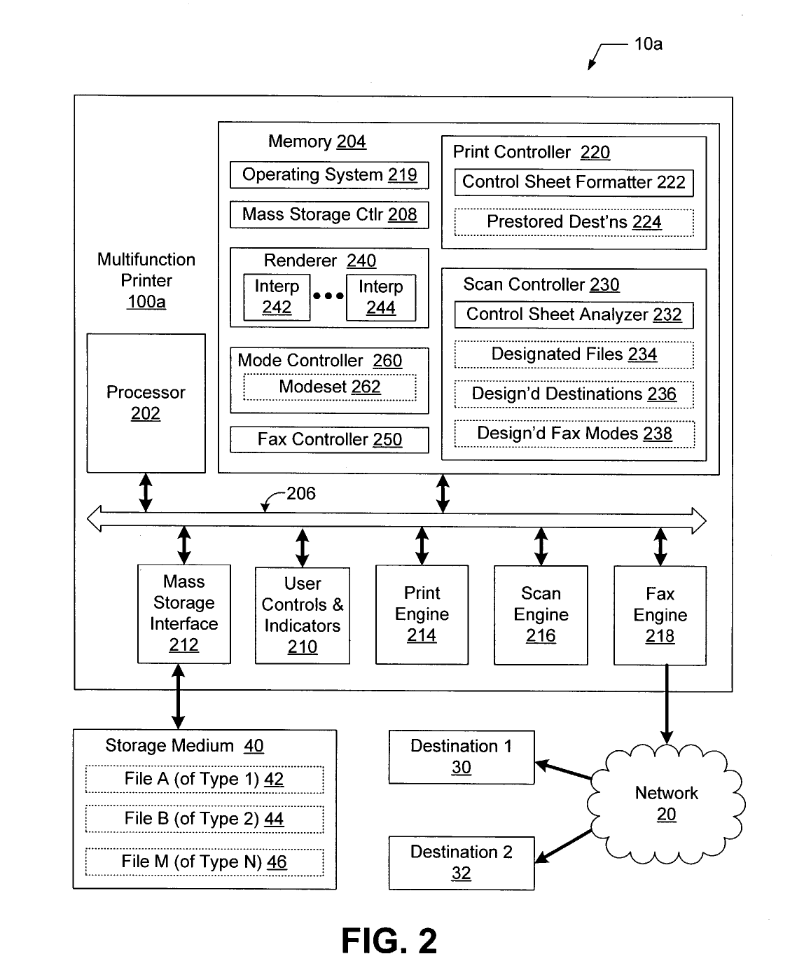

In another embodiment of the present invention, and with reference to FIG. 2, the printer 100a includes a processor circuit having a processor 202 and a memory 204, both of which are coupled to a local interface 206. The local interface 206 may be, for example, a data bus with an accompanying control/address bus as can be appreciated by those with ordinary skill in the art. The printer 100a includes user controls and indicators 210 that collectively provide a user interface for the printer 100a. The user controls and indicators 210 may include, for example, the electronics and mechanics for an LCD display and an arrangement of pushbuttons, etc. The printer 100a also includes a mass storage interface 212 that is communicatively coupled to the local interface 206 and also is adapted to communicatively couple to a storage medium 40. While the storage medium 40 may be permanently coupled to the mass storage interface 212 and reside in the printer 100a, more typically the storage medium is separate from the printer 100a and is intermittently coupled to the mass storage interface 212 when files contained on the medium 40 (for example, files 42,44,46) are to be read or written.

The printer 100a also includes a print engine 214, a scan engine 216, and a fax engine 218. Each of these engines is coupled through appropriate interface circuitry to the local interface 206. The print engine 216 may be, for example a laser printer, an inkjet printer, or other type of printer. Similarly, the scan engine 214 may alternatively be another type of imaging device, while the fax engine 218 may alternatively be another type of communication device, such as, for example, a digital sender capable of sending output data to destinations via e-mail or other computer network applications and protocols.

The printer 100a includes a number of software components that are stored in a computer-readable medium, such as memory 204, and are executable by the processor 202. In this respect, the term “executable” means a program file that is in a form that can be directly (e.g. machine code) or indirectly (e.g. source code that is to be compiled) performed by the processor 202. An executable program may be stored in any portion or component of the memory 204. Each software component comprises logic that implements the functionality of that component. In this regard, the printer 100a includes an operating system 219 that controls the allocation and usage of resources in the printer 100a such as the memory, processing time and peripheral devices. In this manner, the operating system 219 serves as a foundation on which applications can be built and executed. Files on the storage medium 40 are accessed under the control of mass storage controller 208 that controls mass storage interface 212.

The printer 100a contains a print controller 220 software component that controls print engine 214 so as to print a control sheet 50 indicative of a set of files and a set of destinations. The print controller 220 further includes a control sheet formatter 222 that determines the set of files, generates a file representation and file designator for each file, identifies the set of destinations, including prestored destinations 224, and generates a destination representation and destination designator for each destination. In some embodiments the control sheet formatter 222 also generates a mode representation and mode designator for at least one fax mode in a fax modeset.

The printer 100a also includes a scan controller 230 software component that controls scan engine 216 in order to scan the control sheet 50 so as to recognize marks made on the sheet 50 by a user that are indicative of designated files and designated destinations. The scan controller 230 further includes a control sheet analyzer 232 that detects the control sheet 50, locates the marks on the control sheet 50, and, based on the locations of the marks, identifies any designated files 234 and any designated destinations 236. In some embodiments the control sheet analyzer 232 also identifies any designated fax modes 238. The printer 100a also includes a mode controller 260 software component that determines the fax modeset 262 utilizing any designated fax modes 238.

The printer 100a additionally includes a renderer 240 software component that renders the at least one designated file into fax-formatted output data in accordance with the fax modeset 262. The renderer 240 includes at least one data interpreter 242,244 which is capable of appropriately rendering data contained in a file having a particular filetype associated with the data interpreter 242,244. For example, data interpreter 242 may render JPG files, while data interpreter 242 may render DOC files. The printer 100a further includes a fax controller 250 software component that controls fax engine 218 so as to fax at least some of the output data to each at least one designated destination in accordance with the fax modeset 262.

The memory 204 is defined herein as both volatile and nonvolatile memory and data storage components. Volatile components are those that do not retain data values upon loss of power. Nonvolatile components are those that retain data upon a loss of power. Thus, the memory 204 may comprise, for example, random access memory (RAM), read-only memory (ROM), hard disk drives, floppy disks accessed via an associated floppy disk drive, compact discs accessed via a compact disc drive, magnetic tapes accessed via an appropriate tape drive, and/or other memory components, or a combination of any two or more of these memory components. In addition, the RAM may comprise, for example, static random access memory (SRAM), dynamic random access memory (DRAM), or magnetic random access memory (MRAM) and other such devices. The ROM may comprise, for example, a programmable read-only memory (PROM), an erasable programmable read-only memory (EPROM), an electrically erasable programmable read-only memory (EEPROM), or other like memory device.

In addition, the processor 202 may represent multiple processors and the memory 204 may represent multiple memories that operate in parallel. In such a case, the local interface 206 may be an appropriate network that facilitates communication between any two of the multiple processors, between any processor and any one of the memories, or between any two of the memories etc. The processor 202 may be electrical, molecular, or optical in nature.

Although the printer 100a described heretofore a number of software components, as an alternative the components may also be embodied in dedicated hardware, or in a combination of software with general purpose and dedicated hardware. If embodied in dedicated hardware, the components can be implemented as a circuit or state machine that employs any one of or a combination of a number of technologies. These technologies may include, but are not limited to, discrete logic circuits having logic gates for implementing various logic functions upon an application of one or more data signals, application specific integrated circuits having appropriate logic gates, programmable gate arrays (PGA), field programmable gate arrays (FPGA), or other components, etc.

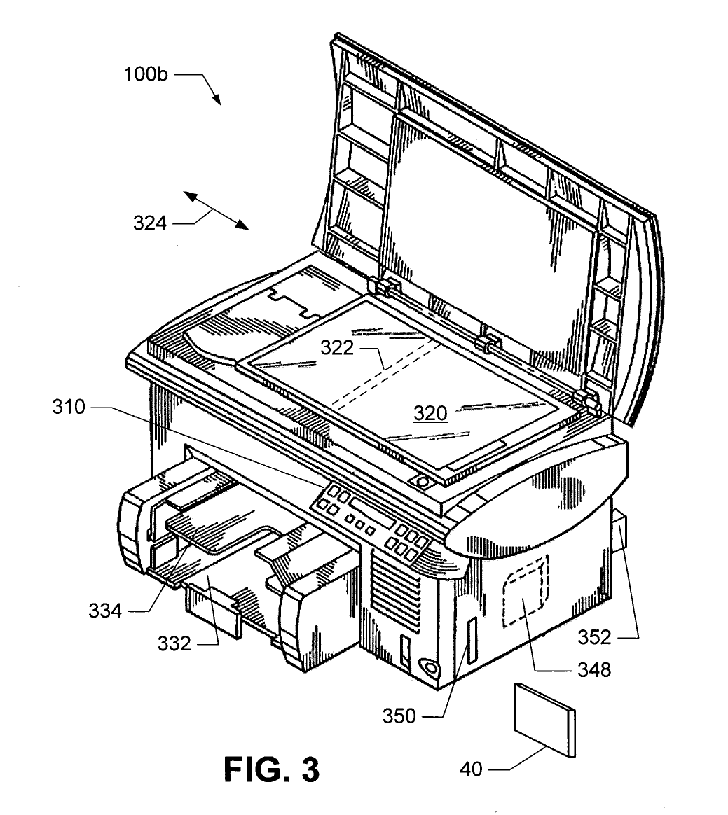

Considering now a further embodiment of the present invention, and with reference to FIG. 3, a multifunction printer 100b, often called an “all-in-one” or an “MFP”, often includes features that allow it to function as at least a printer, a scanner, and a fax. Print media is supplied to input tray 332. During a printing operation, a sheet of media is picked from input tray 332, printed by the print engine 214 (FIG. 2), and placed in output tray 334. A processing module 348 may include processor 202 and a computer-readable storage medium such as memory 204 including the software components described heretofore. The multifunction printer 100b typically contains a memory interface slot 350 that is adapted to receive storage device 40 and access files stored thereon. The multifunction printer 100b also includes user controls and indicators 210 also as heretofore described. The user controls may be manipulated to cause fax control sheet 50 to be printed and delivered to output tray 334.

The printer 100b also includes a scan engine 216 adapted to generate the image data for a physical item placed adjacent the scan engine 216. One embodiment of the scan engine is a flatbed scanner that includes a platen 320 on which the physical item, such as a sheet of media, may be placed, and a scan bar 322. The scan bar 322 typically contains a light source and an array of light detectors arranged along the axis of the scan bar 322 as the scan bar 322 is moved along axis 324. The user controls 210 may be manipulated to cause a fax control sheet 50 positioned on platen 320 to be scanned. In some embodiments, a separate control indicates that the item to be scanned is a fax control sheet 50; in other embodiments, the printer 100b identifies from the scan data that the item being scanned is a fax control sheet 50.

The fax engine 218 (FIG. 2) of printer 100b connects to network 20 via connector 352. Where network 20 is a telephone network, connector 352 may be a standard telephone socket for connecting printer 100b to the telephone network for fax connectivity. As such, multifunction printer 100b can perform the heretofore described printing, scanning, rendering, and faxing operations as a standalone device, without requiring a connection to a computer system. In some configurations, however, printer 100b may also be connected to a computer (not shown).

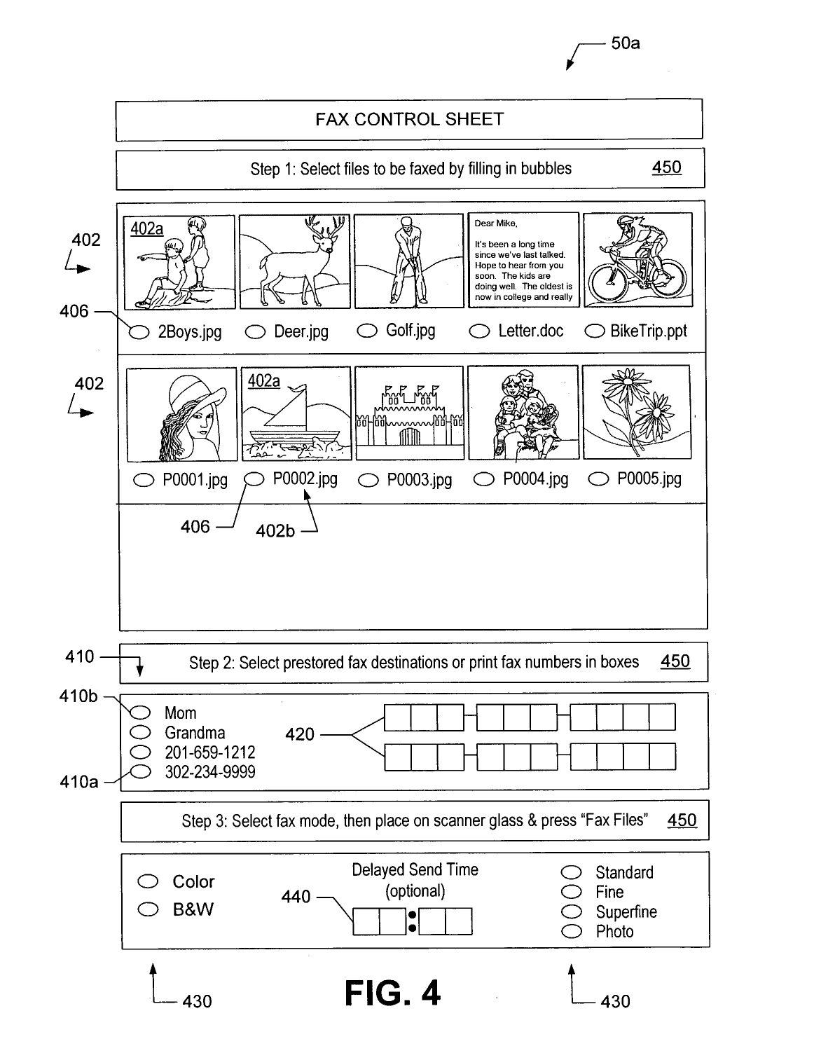

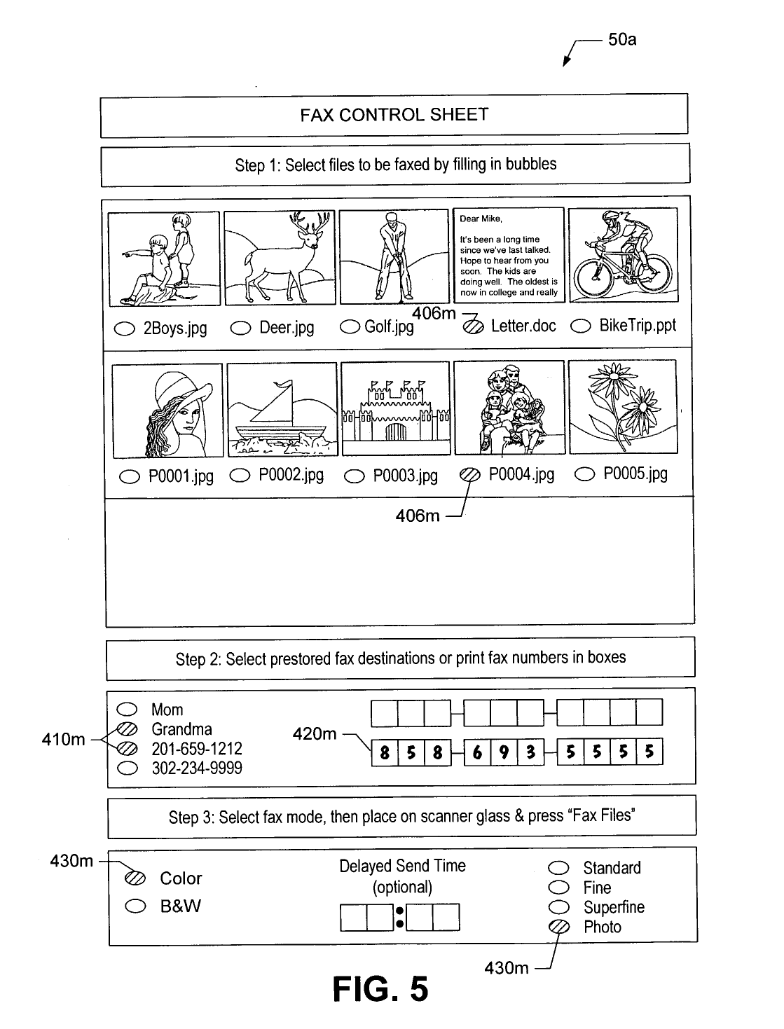

Considering now in greater detail an embodiment of a fax control sheet 50a, and with reference to FIGS. 4 and 5, a fax control sheet 50a typically includes at least one sheet of print media. As printed by the multifunction printer 100, the fax control sheet 50a has one or more file representations, such as file representations 402, each representation 402 representative of a corresponding data file, such as one of data files 42,44,46 (FIG. 1). Each file representation 402 may include a graphical depiction 402a, such as a small “thumbnail” rendition, of at least a portion of the content of the corresponding data file. Each file representation 402 may alternatively or additionally include textual representations 402b of the data file that may include some or all of a file pathname, file type, file creation or modification date, and the like. Adjacent each representation 402 is a corresponding file designator 406. Each file designator 406 includes a region, such as a box, circle, ellipse, line, or the like, which is selectively markable by the user with a marking implement (not shown) such as a pen, pencil or marker, to indicate that the data file corresponding to the marked file designator 406 is a selected data file which is to be rendered in a fax-compatible format and faxed to at least one fax destination. For example, the cross-hatching pattern of file designators 406m (FIG. 5) indicate that the corresponding data files (“Letter.doc” and “P0004.jpg”) are selected data files to be rendered and faxed. Note that cross-hatching is merely illustrative of the type of marking to be entered in file designators 406m; more typically, for example, the entire circle would be filled in. When the marked control sheet 50a is scanned, each marked file designator 406m is recognized and the corresponding data files identified as selected data files.

In some embodiments, the control sheet 50a may also include at least one destination designator indicative of a fax destination to which the selected data files will be faxed after rendering. A first type of destination designator 410 includes a region, such as a box, circle, ellipse, line, or the like. Each destination designator 410 is associated with a numeric or symbolic representation of network address such as a telephone number. Network address representations that are prestored in the printer 100 may be automatically printed on the control sheet 50a. For example, destination designator 410a is associated with the prestored numeric representation “302-234-9999”, while destination designator 410b is associated with the prestored symbolic representation “Mom”. Users typically prestore frequently used telephone numbers in the multifunction printer 100, and often associate a symbolic name with one or more of these numbers for ease of use. Each destination designator 410 is selectively markable by the user with a marking implement (not shown) such as a pen, pencil or marker. For example, the cross-hatching pattern of destination designators 410m (FIG. 5) indicate that the selected data files are to be faxed to a fax number for “Grandma” and to telephone number “201-659-1212”. Note that cross-hatching is merely illustrative of the type of marking to be entered in destination designators 410m; more typically, for example, the entire circle would be filled in. When the marked control sheet 50a is scanned, each marked destination designator 410m is recognized and the corresponding fax destination identified.

A second type of destination designator that may be used with the control sheet 50a is a destination entry field 420 markable by the user with a marking implement so as to indicate a network address such as a telephone number. Typically this telephone number is not prestored in the printer 100. Users typically do not prestore infrequently used telephone numbers in the multifunction printer 100. Each destination entry field 420 is selectively markable by the user, typically with a marking implement (not shown) such as a pen, pencil or marker, in order to specify the telephone number or other network address. For example, the telephone number “858-693-5555” has been entered into the destination entry field 420m (FIG. 5) to indicate that the selected data files are to be faxed to that telephone number. When the marked control sheet 50a is scanned, optical character recognition is performed on the destination entry field 420m to convert the entered writing into the appropriate digital representation of the fax destination.

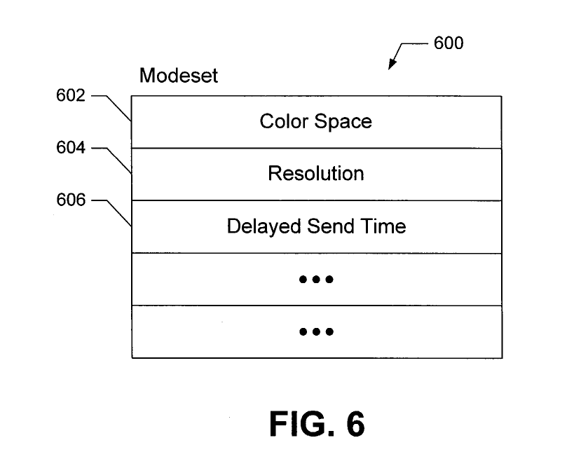

In some embodiments, the fax control sheet 50a may also include representations of one or more fax modes. Each fax mode is indicative of a fax parameter, or parameter value, to be used in rendering a selected data file, faxing the output data, or both. Before considering the control sheet 50a further, it is useful to consider fax modes with reference to the fax modeset 600 of FIG. 6. The fax modeset 600 includes a set of fax parameters that are used in rendering a selected data file, faxing the output data, or both. A color space parameter 602 governs whether the selected data files will be rendered and faxed in color mode or in black-and-white mode. For example, a data file representing a color image will be converted to a grayscale image if black-and-white mode is selected. A resolution parameter 604 governs the resolution at which the faxed image will be rendered and faxed. For example, standard resolution may be 203 by 98 dpi; fine resolution may be 203 by 196 dpi; superfine resolution may be 300 by 300 dpi without halftoning, and photo resolution may be 300 by 300 dpi with halftoning. A delayed send time parameter 606 determines a future time after scanning of the marked control sheet 50a at which the selected data files will be faxed. These fax parameters are merely exemplary and non-inclusive. In addition, some fax parameters or parameter values may not be specifiable by the user via the control sheet 50a.

Returning now to the fax control sheet 50a, and with continued reference to FIGS. 4 and 5, the control sheet 50a also includes at least one fax mode designator indicative of a fax parameter, or parameter value, to be used in rendering a selected data file, faxing the output data, or both. A first type of fax mode designator 430 includes a region, such as a box, circle, ellipse, line, or the like. Each fax mode designator 430 is associated with a fax mode, as previously described. Each fax mode designator 430 is selectively markable by the user with a marking implement (not shown) such as a pen, pencil or marker. For example, the cross-hatching pattern of destination designators 430m (FIG. 5) indicate that the selected data files are to be rendered and faxed according to a “color” color space and a “photo” resolution. Note that cross-hatching is merely illustrative of the type of marking to be entered in destination designators 430m; more typically, for example, the entire circle would be filled in. When the marked control sheet 50a is scanned, each marked fax mode designator 430m is recognized and the corresponding fax destination identified.

A second type of fax mode designator that may be used with the control sheet 50a is a fax mode entry field 440 (FIG. 4) markable by the user with a marking implement. Each fax mode entry field 440 is selectively markable by the user, typically with a marking implement (not shown) such as a pen, pencil or marker, in order to specify a fax mode such as the delayed send time. When the marked control sheet 50a is scanned, optical character recognition is performed on any marked fax mode entry field 440 to convert the entered writing into the appropriate digital representation of the corresponding fax mode.

In some embodiments, the fax control sheet 50a may further include instruction regions 450 that provide textual or graphical instructions to the user for use of the control sheet 50.

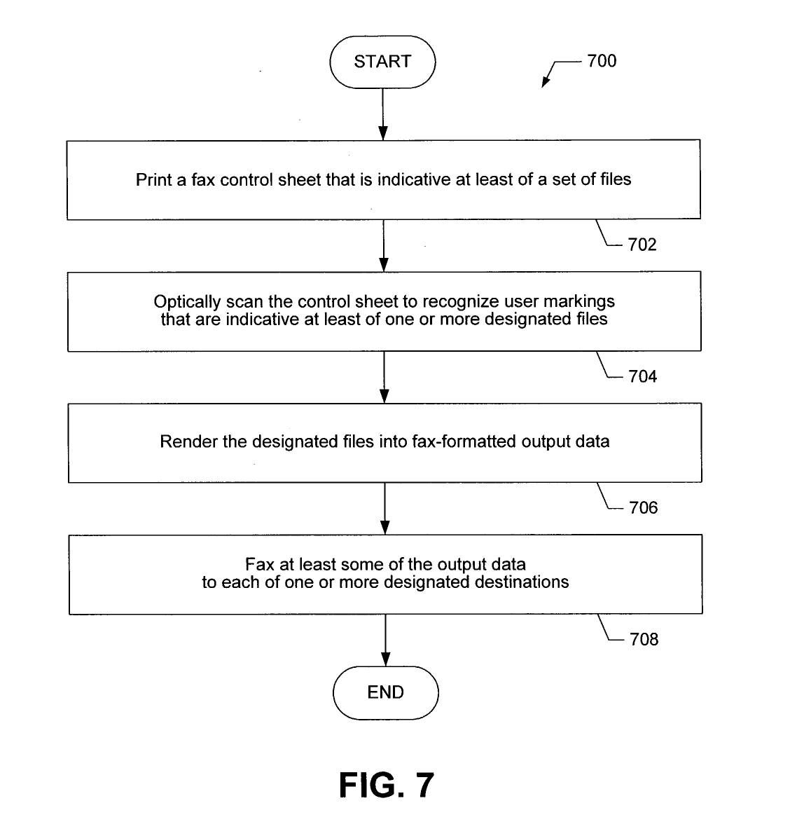

Considering now another embodiment of the present invention, and with reference to FIG. 7, the present invention may also be embodied as a method 700 for use in faxing with a multifunction printer 100. The method begins at 702 by printing a fax control sheet 50 that is indicative at least of a set of files. In some embodiments, as will be described subsequently in greater detail, the control sheet 50 may also be indicative of additional items such as destinations and fax modes. At 704, the control sheet 50 is optically scanned to recognize user markings on the sheet 50 that are indicative at least of one or more designated files. In some embodiments, as will be described subsequently in greater detail, the user markings may also be indicative of additional designated items such as designated destinations and designated fax modes. At 706, the designated files are rendered into fax-formatted output data. At 708, at least some of the output data is faxed to each of one or more designated destinations. The designated destinations may be determined by optically scanning the control sheet 50, may be predetermined, or may be specified to the multifunction printer 100 via the user controls and indicators 210 such as by entering a telephone number. In some embodiments, all of the output data may be faxed to each designated destination. In other embodiments, different portions of the output data may be faxed to different designated destinations as governed by a modified fax control sheet (not shown) that associates an individual destination with each selected file. After 708, the method 700 ends.

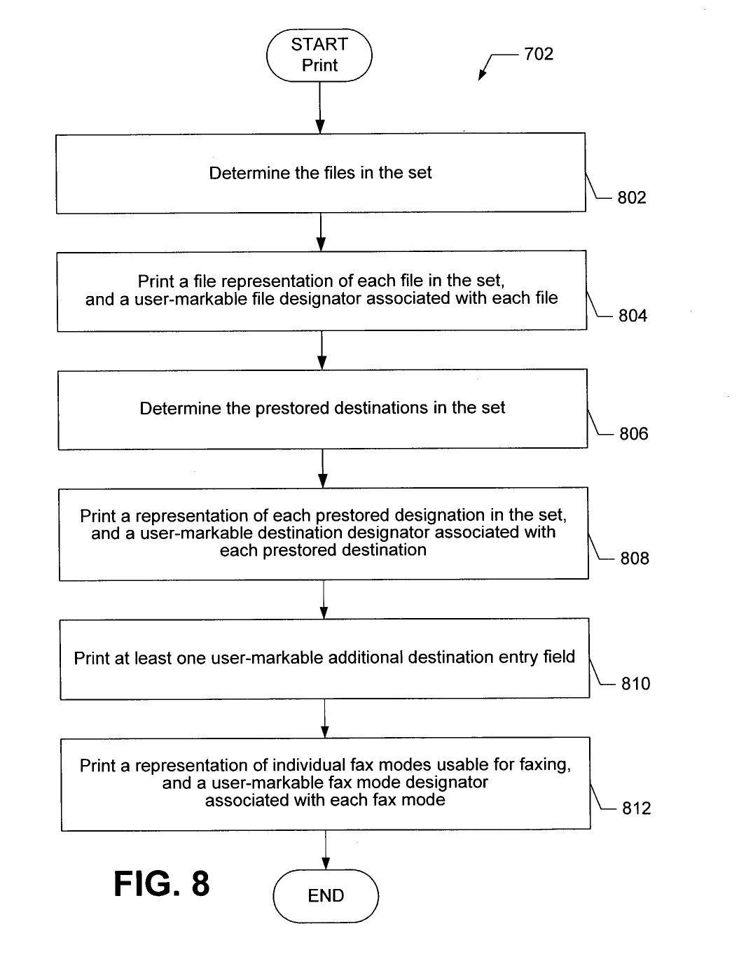

Considering now in greater detail one embodiment of the printing 702 of the fax control sheet 50 indicative at least of a set of files, and with reference to FIG. 8, at 802 the files in the set of files are determined. At 804, a file representation of each file in the set, and a user-markable file designator associated with each file in the set, is printed. At 806, the prestored destinations in the set of destinations is determined. At 808, a representation of each prestored destination in the set, and a user-markable destination designator associated with each prestored destination, is printed. At 810, at least one user-markable destination entry field is printed. At 812, a representation of individual fax modes usable for faxing, and a user-markable fax mode designator associated with each fax mode, is printed. After 812, the printing 702 ends.

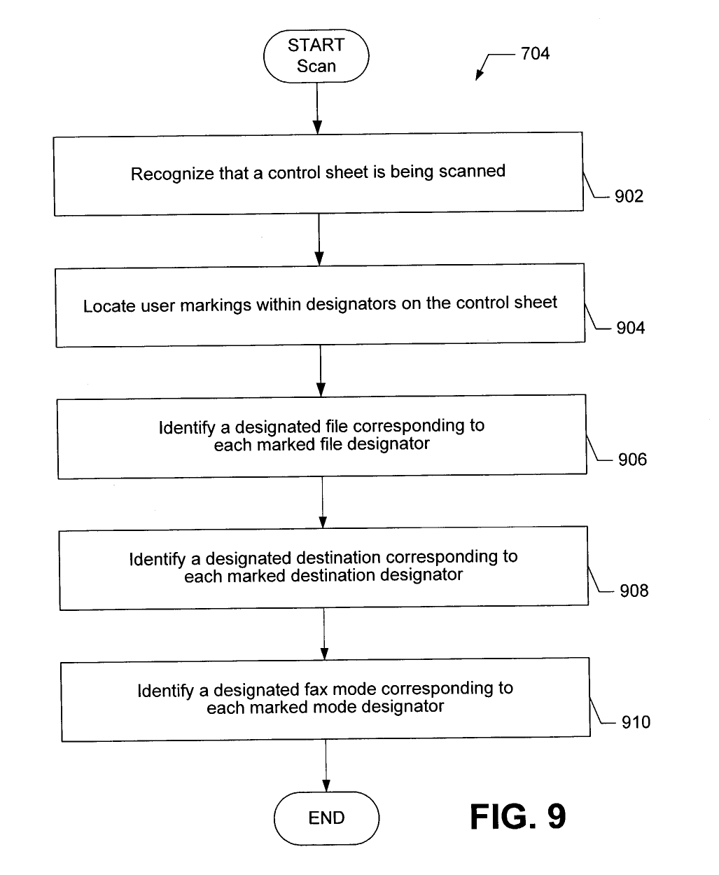

Considering now in greater detail one embodiment of the optical scanning 704 of the fax control sheet 50, and with reference to FIG. 9, at 902 it is recognized that a control sheet 50 is being scanned. In some embodiments, the general layout, such as a set of file representations and files designators, of a control sheet 50 is recognized by analyzing the scan data acquired during the scanning 704. In another embodiment, the control sheet 50 may include readily recognizable fiducial marks or identity markers (not shown) printed on the control sheet 50 and having a unique pattern that is indicative that the scan data represents a fax control sheet 50. The fiducial marks or markers may further be indicative of the orientation of the fax control sheet 50 with respect to a scan subsystem 130 or platen 320. In still other embodiments, a user control of printer 100 may be operated by the user so as to indicate that a control sheet 50 is being scanned. At 904, user markings made within designators on the control sheet 50 are located. In some embodiments, the location on the control sheet 50 of the various designators printed during the printing 702 is stored for use during the scanning 704, and so the locating 904 includes looking for user markings made at or within the stored locations corresponding to designators. At 906, a designated file corresponding to each marked file designator (if any) is identified. At 908, a designated destination corresponding to each marked destination designator (if any) is identified. At 910, a designated fax mode corresponding to each marked fax mode designator (if any) is identified. After 910, the scanning 704 ends.

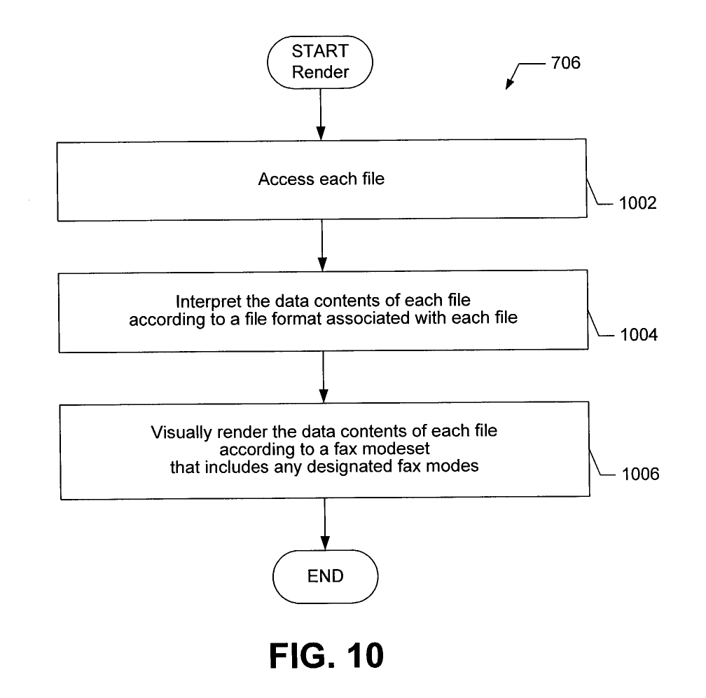

Considering now in greater detail one embodiment of the rendering 706 of the designated files into fax-formatted output data, and with reference to FIG. 10, at 1002 each designated file on the storage media 40 is accessed. At 1004, the data contents of each file are interpreted according to a file format associated with the file. At 1006, the data contents of each file are visually rendered according to a fax modeset that includes any designated fax modes. In some embodiments, a filetype of each file is indicative of the file format, and a data interpreter 242,244 associated with the filetype interprets and visually renders the file into output data formatted for fax data transmission in accordance with the fax modeset. In some embodiments, the visual rendering may include downconverting, upscaling, extrapolating, or interpolating the data. After 1006, the rendering 706 ends.

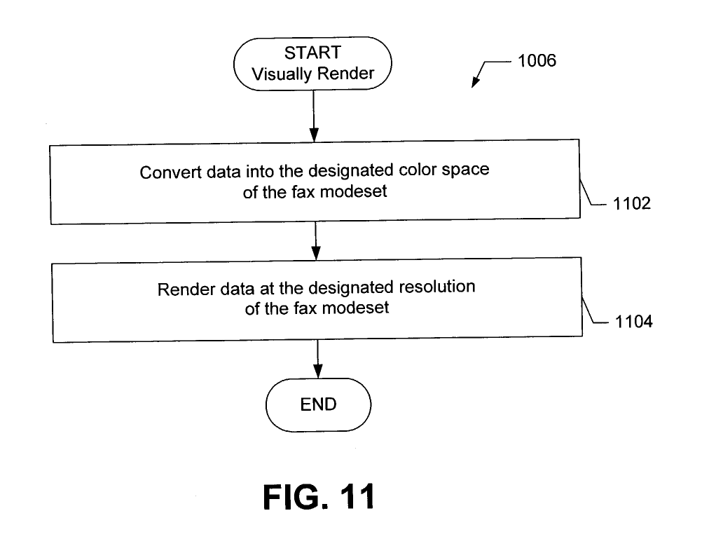

Considering now in greater detail one embodiment of the visual rendering 1006 according to a fax modeset, and with reference to FIG. 11, at 1102 the file data is converted into the designated color space (such as, for example, a color or a grayscale color space) of the fax modeset. At 1104, the converted file data is rendered at the designated resolution (such as, for example, standard, fine, superfine, or photo resolution) of the fax modeset. After 1104, the visual rendering 1006 ends.

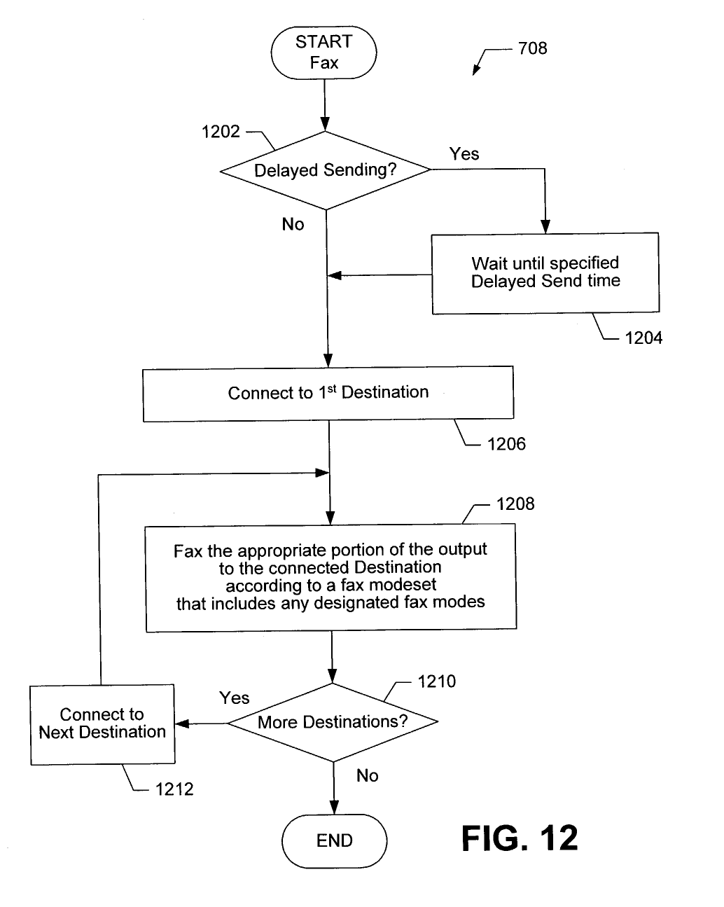

Considering now in greater detail one embodiment of the faxing 708 of the output data, and with reference to FIG. 12, at 1202 it is determined whether a delayed sending fax mode has been designated. If so (“Yes” branch of 1202), then at 1204 the method waits until the specified delayed send time, then continues at 1206. If not (“No” branch of 1202), the method continues at 1206. At 1206, the multifunction printer 100 connects to the first designated destination. At 1208, the portion of the output data that is to be sent to the connected destination is faxed to that destination. The portion may be all the output data, or only that part of the output data that is associated with particular designated files. At 1210, it is determined whether any output data is to be sent to another destination. If so (“Yes” branch of 1210), then at 1212 the multifunction printer 100 connects to the next designated destination. If not (“No” branch of 1210), then the faxing 708 ends.

From the foregoing it will be appreciated that the multifunction printer, fax control sheet, and methods provided by the present invention represent a significant advance in the art. Although several specific embodiments of the invention have been described and illustrated, the invention is not limited to the specific methods, forms, or arrangements of parts so described and illustrated. For example, the control sheet may have a different layout and appearance, and fewer, more, or different elements, than illustrated. As another example, the invention is not limited to use with storage media that is removable from an electronic device; if non-removable storage media is used with the electronic device, the electronic device can be communicatively connected to the multifunction printer through a wired connection such as a cable, through a wireless connection such as RF or infrared, or the like that gives the multifunction printer access to the data files of the electronic device. This description of the invention should be understood to include all novel and non-obvious combinations of elements described herein, and claims may be presented in this or a later application to any novel and non-obvious combination of these elements. The foregoing embodiments are illustrative, and no single feature or element is essential to all possible combinations that may be claimed in this or a later application. Unless otherwise specified, steps of a method claim need not be performed in the order specified. The invention is not limited to the above-described implementations, but instead is defined by the appended claims in light of their full scope of equivalents. Where the claims recite “a” or “a first” element of the equivalent thereof, such claims should be understood to include incorporation of one or more such elements, neither requiring nor excluding two or more such elements.

What is claimed is:

1. A method for use in faxing with a multifunction printer, comprising:
printing a control sheet associated with at least one file accessible by the printer, the control sheet including
a representation of each file,
a user-markable file designator associated with each file, and
at least one user-markable destination designator,
optically scanning the control sheet after marking by a user to detect at least one marked file designator and any marked destination designators;
determining at least one destination from the any marked destination designators;
rendering the file associated with each marked file designator into fax-formatted output data; and
faxing at least some of the output data to at least one of the destinations.

2. The method of claim 1, wherein the scanning further includes:
recognizing the control sheet;
locating the at least one file designator and the at least one destination designator on the control sheet;
analyzing the at least one file designator and the at least one destination designator to locate any user markings therein; and
identifying from the user markings the at least one marked file designator and the any marked destination designators.

3. The method of claim 1, wherein
the printing includes printing a representation of a plurality of fax modes and a user-markable mode designator associated with each fax mode,
the scanning includes detecting any marked mode designators, each marked mode designator indicative of a designated fax mode,
the rendering includes rendering the output data in accordance with a fax modeset that includes any designated fax modes, and
the faxing includes faxing the output data in accordance with a fax modeset that includes any designated fax modes.

4. The method of claim 3, wherein the scanning further includes:
recognizing the control sheet;
locating the at least one mode designator on the control sheet;
analyzing the at least one mode designator to locate any user markings therein;
identifying from the user markings any marked mode designators; and.
identifying from the marked mode designators the corresponding designated fax modes.

5. The method of claim 1, wherein the representation of each file includes at least one of a graphical representation of at least some of the file data and a textual description of the file.

6. The method of claim 1, wherein the user-markable destination designator is at least one of a predetermined telephone number, a predetermined destination name, and a destination entry field.

7. The method of claim 6, further comprising:
obtaining the predetermined telephone number and the predetermined destination name from the multifunction printer.

8. The method of claim 6, wherein the determining further comprises:
performing optical character recognition on user markings in the destination entry field so as to form the destination.

9. The method of claim 8, wherein the user markings comprise characters indicative of at least one of a telephone number and a destination name.

10. The method of claim 1, wherein the rendering further comprises:
accessing the file;
interpreting contents of the file according to a file format associated with the file; and
visually rendering the contents of the file according to a fax modeset that includes any designated fax modes.

11. The method of claim 1, wherein the faxing includes faxing all the output data to each of the destinations.

12. The method of claim 1, wherein the faxing includes faxing according to a fax modeset that includes any designated fax modes.

13. The method of claim 1, wherein the faxing includes delaying the faxing until a specified time after the scanning.

14. A method for use in faxing with a multifunction printer, comprising:
printing a control sheet indicative of a set of files accessible by the printer;
optically scanning the control sheet so as to recognize marks made thereon by a user, the marks indicative of at least one designated file in the set of files;
rendering the at least one designated file into fax-formatted output data; and
faxing at least some of the output data to each of at least one designated destination.

15. The method of claim 14,
wherein at least some designated destinations are part of a set of destinations,
wherein the control sheet is further indicative of the set of destinations, and
wherein the marks are further indicative of the at least some designated destinations.

16. The method of claim 14, wherein at least one designated destination is determined other than by the optically scanning the control sheet.

17. The method of claim 14, wherein the faxing includes faxing all the output data to each at least one designated destination.

18. The method of claim 14, wherein the rendering further comprises:
accessing each designated file;
interpreting contents of each file according to a file format associated with the file; and
visually rendering the contents of each file according to a fax modeset determined from the marked control sheet.

19. The method of claim 14, wherein each file is one of a digital image file and a document file.

20. A multifunction printer, comprising:
means for accessing files stored on a storage medium;
means for printing a control sheet indicative of a set of files accessible by the printer;
means for optically scanning the control sheet so as to recognize marks made thereon by a user, the marks indicative of at least one designated file in the set of files;
means for rendering the at least one designated file into fax-formatted output data; and
means for faxing at least some of the output data to each of at least one designated destination.

21. The printer of claim 20,
wherein at least some designated destinations are part of a set of destinations,
wherein the control sheet is further indicative of the set of destinations, and
wherein the marks are further indicative of the at least some designated destinations.

22. A multifunction printer, comprising:
a mass storage subsystem adapted to access files stored on a storage medium;
a print subsystem coupled to the mass storage subsystem and adapted to print a control sheet indicative of a set of the files and a set of destinations;
a scan subsystem adapted to optically scan the control sheet so as to recognize marks made thereon by a user, the marks indicative of at least one designated file in the set of files and at least one designated destination in the set of destinations;
a renderer coupled to the scan subsystem and the mass storage subsystem, the renderer adapted to render the at least one designated file into fax-formatted output data; and
a fax subsystem coupled to the renderer and adapted to fax at least some of the output data to each at least one designated destination.

23. The printer of claim 22, wherein the mass storage subsystem is adapted to receive the storage medium, and wherein the storage medium is external to the printer.

24. The printer of claim 22, including:
a data store coupled to the print subsystem and adapted to contain prestored ones of the set of destinations.

25. The printer of claim 22, wherein:
the scan subsystem is further adapted to recognize marks on the control sheet indicative of a fax modeset,
the renderer is further adapted to render the at least one designated file in accordance with the fax modeset, and
the fax subsystem is further adapted to fax the output data in accordance with the fax modeset.

26. The printer of claim 25, wherein the scan subsystem is further adapted to indicate at least one designated fax mode marked on the control sheet, the printer further including:
a mode control subsystem adapted to determine the fax modeset from the at least one designated fax mode, and adapted to provide the fax modeset to the renderer and the fax subsystem.

27. A multifunction printer, comprising:
a processor circuit having a processor and a memory;
a print controller stored in the memory and executable by the processor, the print controller comprising logic that prints a control sheet indicative of a set of files;
a scan controller stored in the memory and executable by the processor, the scan controller comprising logic that scans the control sheet so as to recognize marks made thereon by a user, the marks indicative of at least one designated file in the set of files;
a renderer stored in the memory and executable by the processor, the renderer comprising logic that renders the at least one designated file into fax-formatted output data; and
a fax controller stored in the memory and executable by the processor, the fax controller comprising logic that faxes at least some of the output data to each of at least one designated destination.

28. The printer of claim 27, wherein:
at least some designated destinations are part of a set of destinations,
the control sheet is further indicative of the set of destinations, and
the marks are further indicative of the at least some designated destinations.

29. The printer of claim 28, wherein the print controller further includes:
a control sheet formatter comprising logic that determines the set of files, generates a file representation and file designator for each file, identifies the set of destinations, and generates a destination representation and destination designator for each destination in the set.

30. The printer of claim 29, wherein the control sheet formatter further generates a mode representation and mode designator for at least one fax mode in a fax modeset.

31. The printer of claim 28, wherein the scan controller further includes:
a control sheet analyzer comprising logic that detects the control sheet, locates the marks on the control sheet, and identifies the at least one designated file and the at least some designated destinations.

32. The printer of claim 31, wherein the control sheet analyzer logic further identifies at least one designated fax mode of a fax modeset.

33. The printer of claim 27, wherein:
the scan controller further comprises logic that recognizes marks on the control sheet indicative of a fax modeset,
the renderer further comprises logic that renders the at least one designated file in accordance with the fax modeset, and
the fax subsystem further comprises logic that faxes the output data in accordance with the fax modeset.

34. The printer of claim 27, wherein the set of files are contained on a storage medium, the printer further comprising:
a mass storage controller comprising logic that selectively accesses individual ones of the set of files.

35. The printer of claim 27, wherein the renderer further comprises:
at least one data interpreter comprising logic capable of rendering data contained in the at least one designated file, where the file has a particular filetype associated with the data interpreter.

36. The method of claim 27, wherein the printing, scanning, rendering, and faxing are performed by the multifunction printer.

37. The method of claim 36, wherein the multifunction printer is a standalone device unconnected to a computer.

38. A program embodied in at least one computer-readable medium for use in faxing with a multifunction printer, comprising:
code that prints a control sheet indicative of a set of files accessible by the printer;
code that optically scans the control sheet so as to recognize marks made thereon by a user, the marks indicative of at least one designated file in the set of files;
code that renders the at least one designated file into fax-formatted output data; and
code that faxes at least some of the output data to each of at least one designated destination.

39. The program of claim 38,
wherein at least some designated destinations are part of a set of destinations,
wherein the control sheet is further indicative of the set of destinations, and
wherein the marks are further indicative of the at least some designated destinations.

40. The program of claim 38, wherein the code that renders further comprises:
code that interprets contents of each designated file according to a file format associated therewith; and
code that visually renders the contents of each designated file in accordance with a fax modeset determined from the marked control sheet.

41. The program of claim 40, wherein the code that visually renders comprises code that performs at least one of downconverting, upscaling, extrapolation, interpolation, and grayscale conversion.

42. The program of claim 38, wherein the code that faxes further comprises:
code that faxes in accordance with a fax modeset determined from the marked control sheet.

43. A control sheet for faxing data files accessible by a multifunction printer, comprising:
at least one sheet of print media having printed thereon
a plurality of file representations of a corresponding plurality of data files;
a plurality of file designators adjacent each corresponding one of the representations, the file designators having a bounded region selectively markable by the user with a marking implement so as to indicate selected ones of the plurality of data files to be rendered in a fax-compatible format and faxed to at least one destination; and
a plurality of destination designators spaced apart from the graphical representations and the file designators, each destination designator indicative of a fax destination and having a bounded region selectively markable by the user with a marking implement so as to cause the selected data files to be faxed to the fax destination by the multifunction printer when the at least one sheet of print media is optically scanned by the multifunction printer.

44. The control sheet of claim 43, wherein each file representation includes at least one of a graphical representation of at least a portion of the corresponding data file and a textual representation of each data file.

45. The control sheet of claim 43, wherein each destination designator further includes at least one of a printed telephone number, a printed destination name associated with a non-printed telephone number, and a destination entry field markable by the user with a marking implement so as to indicate a new telephone number.

46. The control sheet of claim 43, further including representations of a plurality of fax modes, each representation having a bounded region selectively markable by the user with a marking implement so as to indicate at least one selected fax mode for utilization by the multifunction printer in faxing the selected data files to the fax destination.
